(19) United States
(12) Patent Application Publication
(10) Pub. No.: US 2016/0036734 A1
(43) Pub. Date: Feb. 4, 2016

(54) SHORT MESSAGES

(71) Applicants: RICHARD RUTH, CHURCHTON, MD (US); WILLIAM BURKE, ARNOLD, MD (US); ROBERT REISIG, ELDERSBURG, MD (US); DARA UNG, HARWOOD, MD (US); VIPULKUMAR D. PARMAR, ANNAPOLIS, MD (US)

(72) Inventors: RICHARD RUTH, CHURCHTON, MD (US); WILLIAM BURKE, ARNOLD, MD (US); ROBERT REISIG, ELDERSBURG, MD (US); DARA UNG, HARWOOD, MD (US); VIPULKUMAR D. PARMAR, ANNAPOLIS, MD (US)

(73) Assignee: TELECOMMUNICATION SYSTEMS, INC., ANNAPOLIS, MD (US)

(21) Appl. No.: 14/812,511

(22) Filed: Jul. 29, 2015

Related U.S. Application Data
(60) Provisional application No. 62/031,632, filed on Jul. 31, 2014.

(51) Int. Cl. H04L 12/58; A63F 13/355; A63F 13/71; H04W 4/14

(52) U.S. Cl. CPC H04L 51/02; H04W 4/14; H04L 51/10; A63F 13/355; A63F 13/71; H04W 88/16

(57) ABSTRACT

A message converter can be configured to generate a reply notification message for a gaming server in response to a reply short message provided from a mobile device. The reply short message can be sent in response to an original short message previously sent to the mobile device in response to a request initiated by a client associated with a player of a virtual world implemented by the gaming server.

### CROSS-REFERENCE TO RELATED APPLICATION

This application claims the benefit of priority to U.S. Provisional Application No. 62/031,632, filed on 31 Jul. 2014, and entitled SMS MESSAGING FOR ON-LINE AND OFF-LINE GAMING, the entirety of which is herein incorporated by reference.

### TECHNICAL FIELD

This disclosure relates to short messages related to a virtual world implemented by a gaming server.

### BACKGROUND

A massively multiplayer on-line game (MMOG) (also referred to as an MMO) is a multiplayer video game which is capable of supporting large numbers of players simultaneously. An MMOG is typically played on the Internet. An MMOG can have persistent a virtual world that operates continuously. Such games can be found for most network-capable platforms, including personal computers, a video game console, smartphones and other mobile devices. Some forms of MMOGs can include Massively Multiplayer On-line Role-Playing Games (MMORPGs), Massively Multiplayer Battle Arenas (MMBAs), etc.

Text messaging, or texting, is the act of composing and sending a brief, electronic message between two or more mobile phones, fixed or portable devices over a phone network, such as a wireless carrier network. The term originally referred to messages sent using the Short Message Service (SMS). The term “text message” has grown to include messages containing image, video, and sound content (known as Multimedia Messaging Service (MMS) messages). In the examples given herein, the term “short message” is employed to refer to a text message that includes text and/or other such media.

### SUMMARY

One example relates to a non-transitory machine readable medium having machine executable instructions comprising a message converter that can be configured to generate a reply notification message for a gaming server in response to a reply short message provided from a mobile device. The reply short message can be sent in response to an original short message previously sent to the mobile device in response to a request initiated by a client associated with a player of a virtual world implemented by the gaming server.

Another example relates to a gateway that can include one or more computing devices. The gateway can be configured to receive a notification message from a gaming server that implements a virtual world. The notification message can characterize a message generated by a client associated with an on-line player of the virtual world that is directed to an off-line player of the virtual world. The gateway can also be configured to generate an original short message addressed to a mobile device in response to the notification message. A FROM field of the original short message includes a dynamic code associated with the gateway that uniquely identifies the original short message.

Still another example relates to a gateway that can include one or more computing devices. The gateway can be configured to receive a notification message from a gaming server that implements a virtual world. The notification message can characterize a location in the virtual world and the notification message is sent in response to a loss of communication with a client operated by a given player. The gateway can also be configured to generate a short message addressed to a mobile device associated with the given player in response to the notification message. The short message can include a link accessible by a mobile client stored on the mobile device. The link can direct the mobile client to the gaming server.

Yet another example relates to a method that can include receiving a notification message from a gaming server that implements a virtual world, wherein the notification message includes content directed to an off-line player of the virtual world. The method can also include generating an original short message addressed to a mobile device associated with the off-line player in response to the notification message. A FROM field of the original short message can include a dynamic code that uniquely identifies the original short message. The method can further include generating a reply notification message for the gaming server in response to a reply short message provided from the mobile device.

### BRIEF DESCRIPTION OF THE DRAWINGS

FIG. 1 illustrates an example of a system configured to facilitate the sending and receiving of short messages in a gaming environment.

FIG. 2 illustrates an example of a player profile in a gaming environment.

FIG. 3 illustrates a timing diagram of an example of a system for sending a short message in a gaming environment.

FIG. 4 illustrates a timing diagram of an example of a system for receiving a short message in a gaming environment.

FIG. 5 illustrates another timing diagram of an example of a system for receiving a short message in a gaming environment.

FIG. 6 illustrates a timing diagram of an example of a system for processing a short message.

FIG. 7 illustrates an example of a gateway for sending and receiving short messages in a gaming environment.

FIG. 8 illustrates a flowchart of an example method of sending and receiving short messages in a gaming environment.

### DETAILED DESCRIPTION

In some examples, a user can register a mobile device (e.g., a phone) that is configured to receive and send short messages (such as Short Service Message Service (SMS) messages or other types of user messages) to and from a gaming platform, such as a massively multiplayer on-line game (MMOG). In this manner, a user that is not actively logged on to a game can interact with other participants in the MMOG.

The short message can be sent between a mobile device and a virtual gaming world (a virtual world) utilizing a Transmission Control Protocol/Internet Protocol (TCP/IP) based protocol as an interface to a gaming application programming interface (API). The system can provide the ability for a message to be sent from within a game to a mobile device and the ability to send messages from the mobile device that are received within a game world. This system can be implemented in on-line games, such as multiplayer or persistent worlds like MMOGs, massively multiplayer battle arenas (MMBAs), etc. and off-line games (single player games).

In some examples, the short messages can include an identifier and a keyword (e.g., a command) that can cause interaction between a user profile (e.g., that can be associated with an in-game character or avatar) registered with the game world and another entity (e.g., another user, an in-game bank, an in-game auction house, etc.) within the virtual world.

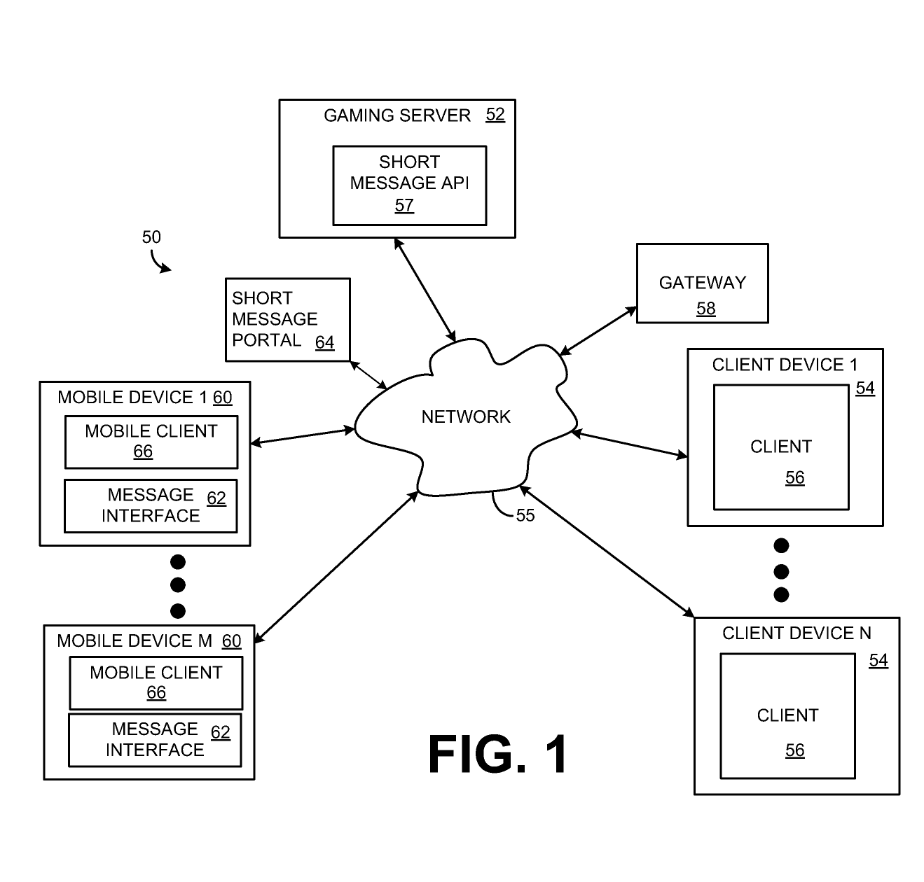

FIG. 1 illustrates an example of a system 50 configured to facilitate the sending and receiving of short messages in a gaming environment. The system 50 is described as being directed to an MMOG that can supports thousands or even millions of concurrent users. However, in other examples, the gaming environment could be limited to a few users or a single user. The system 50 can include a gaming server 52 (e.g., a computing device) that can be configured to implement the gaming environment such as a virtual world. The gaming server 52 can be representative of a plurality of computing devices (e.g., a computing cloud) operating in concert to deploy the gaming environment. Alternatively, the gaming server 52 can be implemented with a single server. Additionally, it is noted that nodes of the system 50 are illustrated and described as performing certain functions. However, in other examples, functions of multiple nodes could be combined into a single node.

The gaming server 52 can communicate with N number of client devices 54 (e.g., N number of computing devices) via a network 55 (e.g., the Internet, a phone network or a combination thereof), where N is an integer greater than or equal to one. Each client device 54 can be implemented as a general purpose computing device, such as a desktop computer, a laptop computer, a mobile device (e.g., a smartphone, a tablet computer), etc. Each client device 54 can include a client 56 executing thereon. The client 56 can be implemented as a software application (e.g., an “app”). The client 56 can facilitate user interaction between a user of the client device 54 and the virtual world provided by the gaming server 52. The virtual world can include virtual instances of banks, stores, auction houses, monsters, environmental features, arenas, etc.

In many MMOGs, the virtual world is persistent, which indicates that the virtual world continues to exist and evolve even after some or all of the users have exited the virtual world (via the clients 56) and that changes made to a state of the virtual world by users (via avatars) or non-playing characters (NPCs) of the virtual world remain intact, such that the virtual world is not “reset” to the original state easily.

Frequently, operations (e.g., adventures) within the virtual world are eased through the employment of multiple different characters (e.g., a group) within the virtual world, wherein each character can correspond to one of the N number of client devices 54, such that each character in the group is an avatar for a user of a corresponding client device 54. However, since the virtual world is persistent, but a user is not playing the game implemented by the gaming server 52 constantly, there are intermittent times when a given user of the virtual world is “off the game” or “off-line”, which indicates that the given user has logged out of the gaming environment and/or is otherwise not participating in the virtual world via a client 56 of one of the N number of client devices 54.

In some examples, the gaming server 52 can include a short message application programming interface (API) 57 that can provide an interface for communication with the gaming server 52 and an external system. The system 50 can include a gateway 58, such as a cloud message center (CMC) that can interface with the gaming server 52 via the short message API 57. The gateway 58 can be configured/programmed to route short messages from the gaming server 52 to M number of mobile devices 60, where M is an integer greater than or equal to one. The gateway 58 can maintain a persistent connection with the gaming server 52 so as to facilitate aggregation of data from users of the system 50 as well as to facilitate the transfer of messages, as described herein. Each of the M number of mobile devices 60 can be implemented, for example, as a smart phone, a feature wireless phone (e.g., a basic wireless phone), a tablet computer, etc. Each mobile device 60 can include a message interface 62, such as a graphical user interface (GUI) or text interface through which a user can send and receive short messages. It is noted that although the gaming server 52 and the gateway 58 are illustrated as being separate nodes, in some examples, the gaming server 52 and the gateway 58 can be integrated together.

The short messages can be implemented as pure text messages and/or messages that include multimedia content. The short messages can be delivered to the M the number of mobile devices 60 or some subset thereof via a public network (e.g., the Internet), a private network (e.g., a wireless carrier network) or a combination thereof. The short messages can be pure text messages, multimedia messages or a combination thereof. The short messages can be delivered by nearly any standard short message protocol. Thus, the short messages can be Short Messaging Service (SMS) messages, Multimedia Messaging Service (MMS) messages or a message conforming to the Extensible Messaging and Presence Protocol (XMPP), such an iMessage service messages, or an Over The Top (OTT) message (e.g., a message delivered through social media), etc.

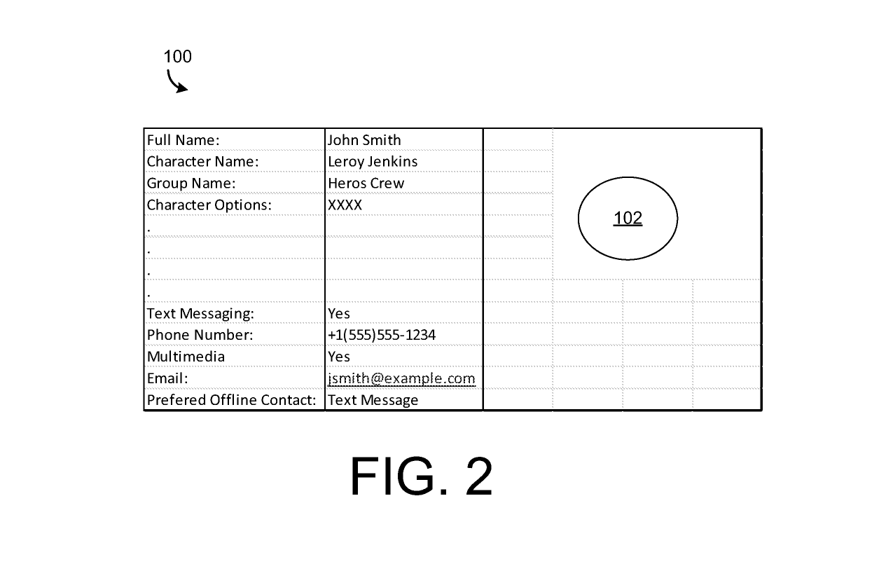

The given user can employ a client 56 of a given client device 54 to edit a user profile for the given user. The user profile can be stored, for example, on the gaming server 52 (e.g., in a database). FIG. 2 illustrates a simplified example of a user profile 100. The user profile 100 can create an association between the given user and a given character (e.g., avatar) in the virtual world. The user profile 100 can be representative of a database record. The user profile 100 can include a field for a name of the user (labeled in FIG. 2 as “FULL NAME”). Additionally, the user profile 100 can include a character name (labeled in FIG. 2 as “CHARACTER NAME”). The name of the character represents the name used by the user for the character in the virtual world. The user profile 100 can include a picture 102 (schematically represented) that can illustrate a picture of the character in the virtual world. In some examples, the user profile 100 of the given user can be associated with a group (e.g., a guild) (labeled in FIG. 2 as “GROUP NAME”). Moreover, the user profile 100 can include an option for the user to receive text messages (short messages), which is labeled in the user profile 100 as “TEXT MESSAGING”. Further, the user profile 100 can include a field to register a telephone number (or other unique identifier) associated with a given mobile device 60. Additionally, the user profile 100 can include a field for an email address (labeled in FIG. 2 as “EMAIL”) associated with the user. In some examples, the user profile 100 can also include an option for sending and receiving multimedia content (labeled in FIG. 2 as “MULTIMEDIA”). The multimedia can be delivered to the given mobile device 60, for example, as a uniform resource locator (URL) link, encoded data, etc. and/or some other method (e.g., email). In some examples, such options can be based on a selected phone model for the given mobile device 60.

Additionally, in some examples, the user profile 100 can include an option for a preferred method of off-line contact with the user (labeled in FIG. 2 as “PREFERRED OFF-LINE CONTACT”). In the present example, the user profile 100 has selected “TEXT MESSAGE”. This could indicate that the user of the user profile 100 prefers to be contacted via short message. In other examples, the user of the user profile 100 could select the preferred method of off-line contact to be email. Additionally or alternatively, in some examples, the preferred method of off-line contact can include multiple options (e.g., both short messages and email). Further, in some examples, the preferred method of contact can include a primary and a secondary method of off-line contact, such as text and then email. In such a situation, the system 50 can be configured such that a short message is send to the user first, and if the user does not reply in a predetermined (or configurable amount of time) (e.g., five minutes), the user is sent a message through email.

Referring back to FIG. 1, in the event that another user employing a client 56 of another client device 54 desires to contact the given user (who is currently off-line), the other user can employ the client 56 to select an identifier associated with the character of the given user, such as a character name, a character identifier, etc. and generate an in-game message (or gaming message) for the given user. Additionally or alternatively, the other user can employ the associated client 56 to generate a group (e.g., a guild) message, wherein the given user is a member of the group. In response, the gaming server 52 can determine that the given user is not currently on-line and convert the gaming message into a notification message and provide the notification message to the gateway 58 along with the telephone number (or other identifier) of the given mobile device 60 as well as an identifier of a character of the other user. In some examples, additional or alternative information can be provided in the notification message, such as a username and/or full name of the given user. Communications between the gateway 58 and the gaming server 52 can be conducted over nearly any TCP/IP protocol, including a secure protocol. Some such protocols include, but are not limited to the Simple Mail Transfer Protocol (SMTP), Short Message Peer-to-Peer (SMPP), Representational State Transfer (REST), Wireless Communications Transfer Protocol (WCTP), MM7, etc.

The gateway 58 can convert/format the notification message into a specific short message format, such as SMS, MMS, iMessage, or an OTT message etc. The content of the short message can be the same (or modified) version of the text generated for the in-game message by the other user. The gateway 58 can set the FROM field of the short message to a dynamic code selected from a pool of dynamic codes that uniquely identifies the short message. In some examples, a tag that identifies the other user (e.g., a character name) can be added to the short message and/or the identifier of the other user can be added to the content of the short message. The dynamic code can be a string of characters that that is compatible with the format of the short message and uniquely identifies the short message, such that replies to the short message can be generated in the manner described herein. Each dynamic code in the pool of dynamic codes can be registered for and/or associated with the gateway 58, such that subsequent reply short messages can be routed back through the gateway 58.

Moreover, the TO field of the short message can be set to the phone number of the mobile device 60 associated with the given user. The gateway 58 can forward the short message to a short message portal 64. The short message portal 64 can be implemented, for example, as an inter-carrier short message gateway, such as an SMS gateway, an iMessage gateway, an MMS message gateway, or an OTT message gateway, a combination thereof, etc.

The short message portal 65 can route the short message to the given mobile device 60 (using secure or unsecure protocols), where the given mobile device 60 can display the short message to the given user via the message interface 62. The short message can appear to be sent “FROM” the dynamic code added by the gateway 58. Alternatively, the short message can appear to be “FROM” an identifier (e.g., a character name) of the character associated with the other user. It is noted that for purposes of simplification of explanation, some components, such as a short message server and/or a cellular communication tower logically connected between the gateway 58 and the mobile device 60 have been omitted.

It is noted that in some examples, the short message may be converted into a different format prior to sending the short message to the given mobile device 60. For instance, in some situations, the short message may be converted by the short message portal 65 (or another constituent component) into an email message. In such a situation, the email message can be addressed to an email address associated with the given mobile device, such an a format of “5555555555@example.com”, where “5555555555” represents the telephone number of the mobile device 60 and “example.com” represents a domain name of a wireless carrier for the mobile device 60.

Upon reading the short message, the given user may elect to reply to the short message. The message interface 62 can be employed by the user to generate a reply short message (e.g., an SMS message, MMS message, an iMessage, or an OTT message or other user message, such as an email message) using an input device such as a keyboard, a keypad (including a virtual keypad) a microphone (e.g., using text-to-speech software) associated with the message interface 62. The mobile device 60 can set the TO field of the reply short message to the value in the FROM field of the (original) short message, which can be the dynamic code of the (original) short message. The FROM field of the reply short message can be set to the telephone number of the mobile device 60 associated with the given user. The reply short message can be securely or un-securely sent to the short message portal 64.

The short message portal 64 can associate the reply short message (from the original short message) with the gateway 58 based on the dynamic code in the TO field of the reply short message, and the reply short message can be forwarded to the gateway 58. The gateway 58 can release the dynamic code back into the dynamic code pool. Additionally, in some examples, the gateway 58 can replace the telephone number of the given mobile device 60 with the identifier of the character (e.g., the character name) associated with the given user. In other examples, the TO field of the reply short message may remain unchanged. The gateway 58 can convert the reply short message into a response notification message and forward the response notification message to the gaming server 52 via the short message API 57.

The gaming server 52 can process the response notification and take appropriate action. In some situations, such action can include, but is not limited to generating a response in-game message for the other user that outputs text included in the response notification message, processing a request with a command identifier in the response notification message, etc. In this manner, bi-directional communications between the given user and the other user are possible, even in situations where the other user is “in-game” (or “on-line”) and the given user is “off-line” relative to the virtual world (also referred to as “out-of-game”). Moreover, such bi-directional communications can commence with a degree of anonymity. In particular, each user (the given user and the other user) would only need to know the identifier for the character (e.g., the character name). Identification information including a real name of the given user and the other user, a telephone number of the given mobile device 60, street addresses, etc. could be obfuscated from the given user and the other user.

Additionally, as noted, the reply short message can include a command identifier with a request for a specific action. In some situations, commands related to sending virtual currency, reinforcements, etc. can be processed by the gaming server 52. In this manner, off-line players (also referred to as “out-of-game players”) can still influence the virtual world. As used herein the term “player” denotes a registered user of the gaming server 202 that can participate in the virtual world implemented by the gaming server 202. At any given time, each such player can be “on-line” (e.g., “in-game”) or “off-line” (“out-of-game”). It is noted that the terms “on-line” and “off-line” refer to connectivity status relative to the virtual world. That is, an off-line player may (or may not) have Internet connectivity independent of whether the player is currently logged-in to the virtual world.

Furthermore, in some examples, each of the M number of mobile devices 60, or some subset thereof, can execute a mobile client 66. The mobile client 66 can be, for example, a client that provides a subset of the features of the client 56 executing on one of the N number of client devices 54. In some examples, the mobile client 66 can include features not available to the client 56. In other examples, the mobile client 66 can provide the same (or nearly the same) functionality as the client 56.

In some examples, the gaming server 52 can be configured to detect a connection status associated with each of the N number of clients. In some instances, the gaming server 52 can be configured to provide a URL with a specific location in the virtual world to a mobile device 60 associated with a given player in response to detecting a crash a loss of communication with a client 56 employed by the given player. The URL, upon activation, can allow the mobile client 66 to re-enter the virtual world at the specific location. Additionally or alternatively, in some examples, the URL can include a link to download the mobile client 66. In this manner, the mobile client 66 can operate as a back-up client in the event that communication is lost at a client 56 (e.g., in response to a computer and/or network crash).

Each of the M number of mobile devices 60 (or some subset thereof) can be equipped with geolocation information. In some examples, the geolocation information could be a global position system (GPS) that operates on the mobile device 60. In other situations, the location of a mobile device 60 can be derived via triangulation. In either situation, the mobile client 66 can periodically (or in response to a request) push a location of a corresponding mobile device 60 to the gateway 58.

The gaming server 52 can be configured to allow an user that is presently on-line, which can be referred to as an on-line player (on “in-game player”) to contact other users and/or specific groups of users of the virtual world that are within a given area, such as within a radius from the on-line player (e.g., a radius of 50 miles) and/or within a geographic region (e.g., a specific metropolitan area). In such a situation, the gaming server 52 can query the gateway 58 for a list of players (either on-line or off-line) that are within the given area.

In response, in some examples, the gateway 58 can be configured to query each of the M number of mobile devices 60 (or some subset thereof) for a current location. In other examples, such as situations where the mobile client 66 periodically pushes the query may be omitted. For each mobile device 60 with a location within the given area, the gateway 58 can identify a character (e.g., a character name) associated with a corresponding device. Moreover, the gateway 58 can send the gaming server 52 (e.g., via the short message API 57) a list of characters that have users within the given area. The list of users can be filtered based on user settings (e.g., privacy settings and/or search qualifiers provided by the in-game use, friends lists, etc.), and the filtered list can be sent to the on-line player. In this manner, a list of characters with players that are on-line (“in-game”) and/or off-line (relative to the virtual world) can be provided to the on-line player. Alternatively, instead of providing such a list of characters, the user can simply specify a message to be sent, and the gaming server 52 can forward the message (as at least one of an in-game message and a short message to a mobile device 60) to the users on the filtered list.

Similarly, an off-line player can send a short message to a specific identifier associated with the gaming server 52 (e.g., a server identifier), the gateway 58 and/or another user of the gaming server 52 for a query of users within a given geographic area. For instance, such a short message could be implemented with the text string “#SEND TEXT TO USERS WITHIN 50 MILES MEET AT JENKINS TAVERN AT 7:00 P.M. TONIGHT”. In such a situation, the gateway 58 can be configured to determine a location of the off-line player to determine the given area. Moreover, in some examples, the gateway 58 can query each of the M number of mobile devices 60 (or some subset thereof) for a current location. For each mobile device 60 located within the given area, the gateway 58 can identify a character (e.g., a character name) associated with the corresponding device. The gateway 58 can provide the list of mobile devices 60 and/or character identifiers that are within the given area as well as the text “MEET AT JENKINS TAVERN at 7:00 P.M. TONIGHT”. The gaming server 52 can filter the list of mobile devices 60 and/or character identifiers and send the text as a message to each user on the resultant filtered list through a combination of in-game messages or short messages to mobile devices 60.

In some examples, functionality such as parental controls can be included at the gateway 58 and/or the gaming server. The parental controls can, for example limit time periods when short messages can be sent to and/or from users of the system 50. Additionally or alternatively, such parental controls can monitor the short messages for the inclusion of inappropriate language.

Further, functionality such as SPAM control can be included at the gateway 58 and/or the gaming server 52. The SPAM control can, for example limit the number and/or nature of messages sent to on-line or off-line players.

Still further, the gaming server 52, the gateway 58 and/or a mobile device 60 can be configured such that short messages associated with the aforementioned on-line player are provided to the on-line player via a client 56 of the associated client device 54. Such messages may be completely unrelated to the virtual world operating on the gaming server 52. In such a situation, the gateway 58, the gaming server 52 and/or the mobile device 60 can implement a copy-forward process such that content (e.g., text and/or other media) of the short messages are sent to both a mobile device 60 associated with the on-line player, as well as the client 56 of the associated client device 54 (e.g., as in-game messages).

By implementing the bi-directional communications and/or commands for controlling in-game content via short messages, as described herein, a number of advantages can be realized. For example, off-line players can be contacted or recruited using only an identifier for the character (e.g., the character name) even if a corresponding user's real name and/or telephone number is unknown. Additionally, schedules can be more easily coordinated among groups of players using, for example, calendar software that is external to the virtual world provided by the gaming server 52. Further still, in critical in-game situations, off-line players can still provide assistance that can directly influence the virtual world via short messages.

Moreover, numerous “in-game scenarios” (situations occurring in the virtual world) can be resolved by employing the bi-directional communications described herein. In a first in-game scenario, an in-game player may encounter a situation where a character with a known identifier is needed (e.g., wherein the need is based on attributes of the character) to perform a specific in-game task, and the user associated with the character is off-line (e.g., an off-line player). In such a situation, the in-game player can send a message (which can be converted into a short message) to the character with a text asking the off-line player of the character if the character would like to join a group. By using this system 50, an in-game alias (e.g., a character name) could be used, such that the in-game player need not know the name of the off-line player and/or a telephone number associated with the off-line player.

In a second scenario, the in-game player may desire to form a group of players “on the fly” or in advance for attain a particular achievement, group content, etc. but the in-game player is unware of any other in-game player that wants to join the group. Additionally, in the second scenario, in-game content such as a “Looking For Group Queue” does not yield satisfactory results in an acceptable timeframe. In the second scenario, the on-line player can create groups that users can opt-in to or opt-out of using an associated mobile device 60. For example, when looking for players, the on-line player can send a message to the appropriate group (which group can be are created based on an in-game need) and the group would be filled and/or reserved based on which users responds to the invites first and/or are highest rated. In such a situation, if a user that joined the group does not log in to the virtual world within a specific configurable time-frame, the user can be removed from the group such that another message can be sent out for to facilitate finding a replacement.

In a third scenario, the on-line player desires to communicate with a particular player (e.g., a user on a friend list), but the user associated with the particular player is off-line. In such a scenario, the on-line player can employ an in-game private chat to facilitate the sending and receiving of short messages with the user (an off-line player) associated with the particular player. The gaming server 52 can provide a mechanism (e.g., profile settings) allowing users to opt-in/out of such short messages and/or based on an approved friends list (e.g., privacy settings), etc.

In a fourth scenario, the on-line player belongs to a group (e.g., a team) in the virtual world, which can be referred to as a guild, and the on-line player is a leader on the team. In such a situation, the on-line player can send a message to each member of the team (or some subset of team members) notifying every team member of an upcoming event or nearly anything else. In such a scenario, the gaming server 52 and/or the gateway 58 can be configured to implement social group alerts, such that some of the team members can receive an in-game message, and other (off-line) team members can receive a short message that provides the notification.

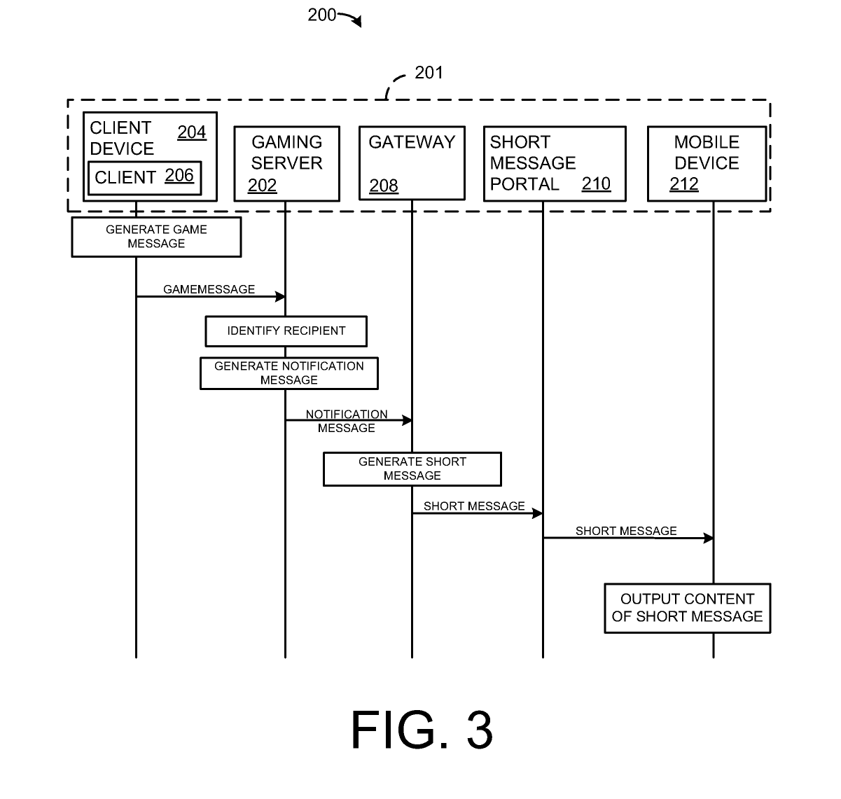

FIG. 3 illustrates a timing diagram 200 for a system 201 for implementing short messages in a virtual world (e.g., a game environment). The system 201 can include nodes that communicate over a public network, such as the Internet, a private network, such as a wireless carrier network or a combination thereof. The system 201 can include a gaming server 202. The gaming server 202 can be implemented, for example, as a stand-alone server or cloud server. In some examples, the gaming server 202 can be implemented in a manner similar to the gaming server 52 illustrated in FIG. 1.

The system 201 can include a client device 204 (e.g., a computing device) that includes a client 206 executing thereon. The client device 204 can be implemented in a manner similar to one of the N number of client devices 54 illustrated in FIG. 1. For purposes of simplification of explanation, in FIG. 2, only one client device 204 is illustrated, but in other examples, multiple (often up to millions) of client devices can be implemented. The client 206 of the client device 204 can be a gaming client that can provide a graphical user interface (GUI) for the virtual world. The client 206 can be in communication with the gaming server 202 (e.g., via a network, such as the Internet).

The client 206 of the client device 204 can be controlled by a user that is currently logged in with the gaming server. Thus, the user of the client 206 can be referred to as an “on-line player”. The on-line player can employ the client 206 to generate a notification for another player, wherein the other player is not currently logged on to the gaming server 202, such that the other player can be referred to as an “off-line player”. In some examples, the client 206 can provide an indication (e.g., via the GUI) that the off-line player is in fact, off line. The notification can be referred to as an in-game message. The in-game message can include content can vary greatly based on the current situation, and some such situations are discussed herein. The in-game message can be addressed, for example to a character name, wherein the character name is associated with the off-line player.

The in-game message can be provided to the gaming server 202. The gaming server 202 can identify the off-line player. To identify the off-line player, the gaming server 202 can access a player database, a player lookup table or other data structure to retrieve a player record associated with the character name identified in the in-game message, namely, the off-line player. The player record could be implemented, for example, to include fields for a user profile, such as the user profile 100 illustrated in FIG. 2.

The player record can include an option for receiving messages while the associated user is off-line. In such a situation, the player record can also include a telephone number (or email address) associated with the off-line player. The gaming server 202 can generate a notification message. The notification message can be a TCP/IP message. The notification message can include the content of the in-game message, as well as an identifier for the sender of the in-game message. In some examples, the identifier of the sender of the in-game message can be a character name associated with the on-line player. Additionally, the notification message can include a telephone number for the off-line player. The notification message can be sent (e.g., via the network) to a gateway 208. The gateway 208 can be a CMC (e.g., a gaming message gateway). In some examples, the gateway 208 can be implemented in a manner similar to the gateway 58 illustrated in FIG. 1.

The gateway 208 can generate a short message (e.g., an SMS message, an MMS message, an iMessage, or an OTT message, etc.) based on the notification message. The TO field of the short message can be set to the telephone number associated with the off-line player. The FROM field of the short message can be set to a dynamic code selected from a dynamic code pool that uniquely identifies the short message. In some examples, the character name of the on-line player can also be included in the short message (e.g., as a tag or in the content (payload) of the short message. The content of the short message can also include the content that was included in the original in-game message. Alternatively, the FROM field of the short message can be set to a telephone number associated with the gateway 208. In this situation, the gateway 208 can add a tag to the short message that identifies the on-line player (e.g., a character name).

As noted, in some situations, instead of a telephone number for the off-line player, the player record can include an email address. In this example, rather than generating a short message, the gateway 208 can generate an email message for the off-line player, where the TO field of the email message is set to the email address of the off-line player, and the FROM field of the email message is set to an email address of the gateway 208, with a disposable (or persistent) email address assigned to the on-line player. In this situation, the gateway 208 can route the email message to the email address in the TO field.

However, assuming that the gateway 208 generates a short message, the gateway 208 can provide the short message to a short message portal 210. The short message portal 210 can be an inter-carrier short message gateway, such as an SMS gateway, an MMS gateway, an iMessage gateway, or an OTT message gateway, etc. The short message portal 210 can forward the short message to a mobile device 212 via a wireless network or a public network (e.g., the Internet).

The mobile device 212 can be implemented, for example, as one of the M number of mobile devices 60 illustrated in FIG. 1. The mobile device 212 can output the content of the short message (e.g., via a GUI or a text interface) to the off-line player. In some examples, the short message may need no reply. For instance, if the short message (based on the in-game message generated by the on-line player) is a request to join the game that may include a specific time or place, the off-line player may simply access another client device with another client and log-on to the gaming server 202.

In other examples, other actions may be taken by the off-line player. For instance, in some examples, the in-game message generated by the client 206 can include multimedia content (e.g., a screen shot or video clip of the virtual world). In this situation, the short message sent to the off-line player can include the multi-media content. In situations where the mobile device 212 provides a mechanism for outputting such multimedia content (e.g., a GUI), the multimedia content can be provided directly to the off-line player. In situations where the mobile device 212 does not support such multi-media content, other mechanisms, such as a URL link, an email message, a viewing portal, etc. can be provided to allow the off-line player to employ a different computing device to access the multi-media content.

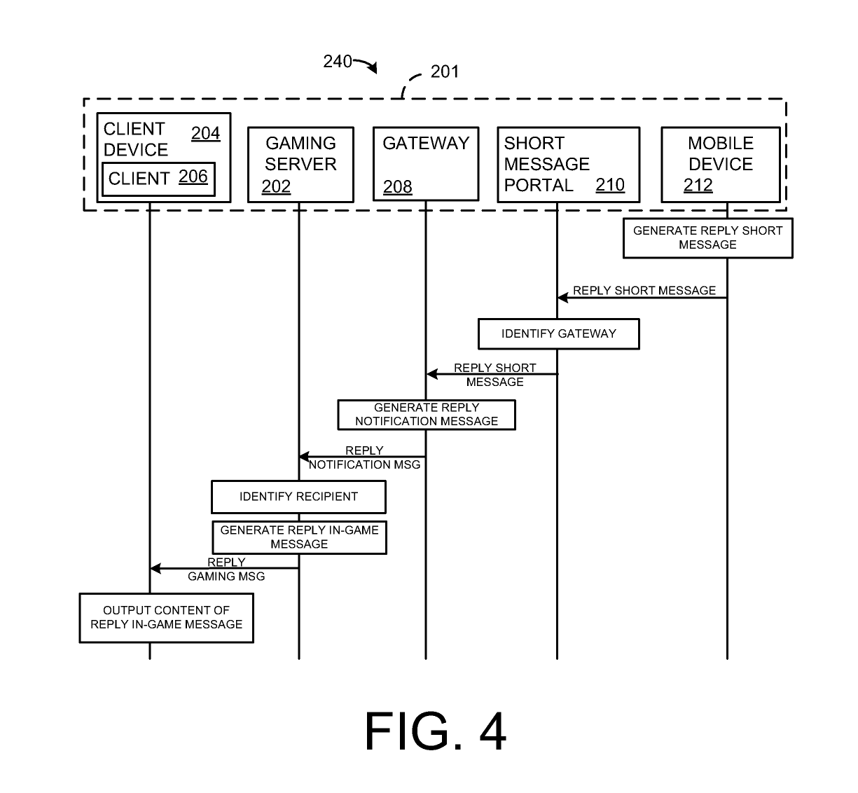

There are numerous other actions that can be taken by the off-line player in response to the output of the content of the short message. FIGS. 4-6 each illustrate a continuation of the timing diagram 200 illustrated in FIG. 3 with different examples of content of the in-game message generated by the on-line player. Thus, for purposes of simplification of explanation, FIGS. 3-6 employ the same reference numbers to denote the same structure.

FIG. 4 illustrates a timing diagram 220 for the system 201 where the in-game message generated by the client 206 can contain a text message, such as a question to which the off-line player elects to reply. In the timing diagram 220, the off-line player can initiate a conversation with the on-line player. In such a situation, the mobile device 212 can generate a reply short message. The reply short message can be a reply to the (original) short message. The TO field of the reply short message can include the identifier in the FROM field of the (original) short message (a dynamic code) and a FROM filed of the reply short message can be the telephone number associated with the mobile device 212. The reply short message can be provided to the short message portal 210. The short message portal 210 can identify the gateway 208 from the reply short message (e.g., by the dynamic code in the TO field of the reply short message). The short message portal 210 can forward the reply short message to the gateway 208. In such a situation, the gateway 208 can receive the reply short message and generate a reply notification message. In some examples, the reply notification message can have a “FROM” field with an identifier of the character associated with the off-line player. In other examples, the reply notification message can have a FROM field with a telephone number of the mobile device 212. The gateway 208 can forward the reply notification message to the gaming server 202. The gaming server 202 can identify the recipient of the on-line player from the reply notification message.

The gaming server 202 can convert the reply notification message to a reply in-game message and push the reply in-game message to the client 206 of the client device 204 employed by the on-line player. The reply in-game message can be output at the client 206 such that the client 206 can display the content of the reply short message (that can include, for example, multimedia content as well as text) to the on-line player.

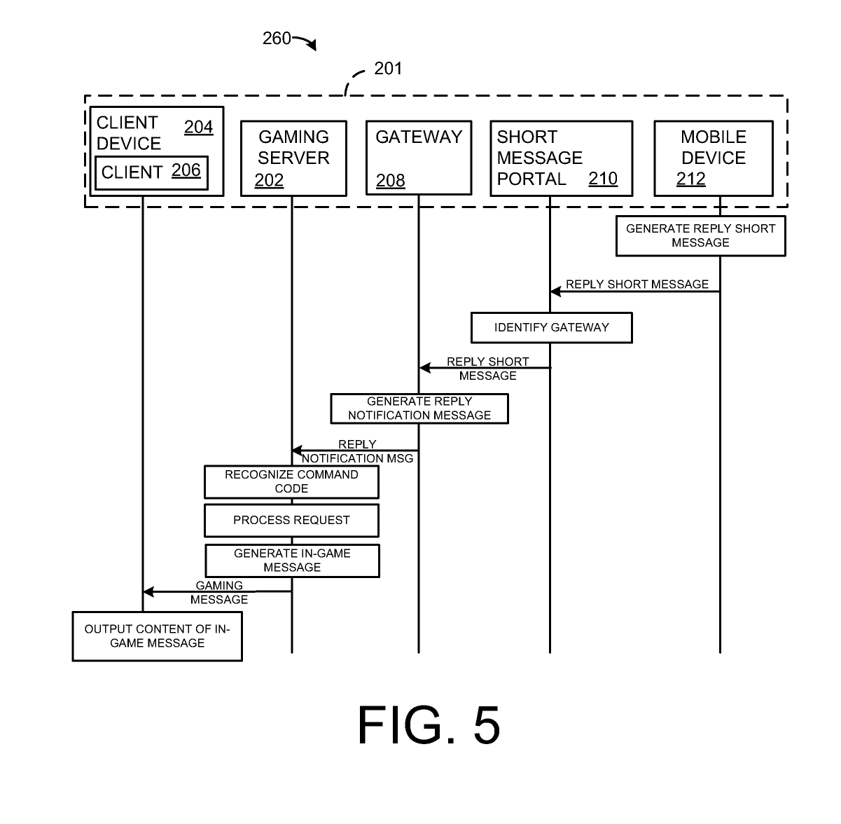

FIG. 5 illustrates a timing diagram 260 for the system 201 where the in-game message generated by the client 206 contains a text message, such as a request for resources. In the timing diagram 220, the off-line player can employ the mobile device 212 to generate a text message with a command identifier (e.g., a text character) that can indicate that text following the command identifier is a keyword (e.g., an in-game command). For example, a text string of “#SEND 50 GOLD” included in the reply short message to a character associated with the on-line player could be generated by the mobile device 212 in response to user input.

The reply short message could be processed by the short message portal 210 and the gateway 208 in the same manner that the reply short message of the timing diagram 220 is processed. Thus, for purposes of simplification of explanation, those actions are not repeated.

Upon receiving a reply notification message from the gateway 208 that includes the content of the reply short message with the command identifier (the ‘#’ character). The gaming server 202 can recognize the notification message as including a command code. Additionally, the gaming server 202 can process the request included in the notification message. For instance, in the situation where the reply short message includes the text string of “#SEND 50 GOLD”, the gaming server 202 can interpret the text “SEND 50 GOLD” as having a keyword of “SEND GOLD” and a parameter of “50” that can cause the gaming server 202 to deduct a certain amount of virtual currency (50 GOLD) from the user profile of the off-line player and credit the user profile of the on-line player (identified in the reply notification message) with virtual currency. In a similar fashion, commands such as sending reinforcements, selling or buying inventory items could also be allowed. The permitted actions can vary based on a nature of the virtual world implemented by the gaming server 202. In some examples, the original message from the on-line player can include an authorization request for a specific action, and a reply short message can include such authorization as the in-game command. For instance, the in-game message to the off-line player could be “REQUEST: SEND 100 GOLD?” In such a situation, the off-line player could reply with text such as “#YES”) that could act as an command identifier (the ‘#’ symbol) and authorization “YES”).

In some examples, the gaming server 202 can generate an in-game message for the on-line player confirming that the request has been processed. For instance, in the situation where the reply short message includes “#SEND 50 GOLD” the in-game message might indicate that ‘50’ gold has been deposited into an account associated with the on-line player. The in-game message can be provided to the client 206 and the client 206 can output the content of the in-game message. In this manner, even though a player is off-line (relative to the virtual world), the off-line player can still employ the given mobile device 212 to interact with and/or influence the virtual world via short messages.

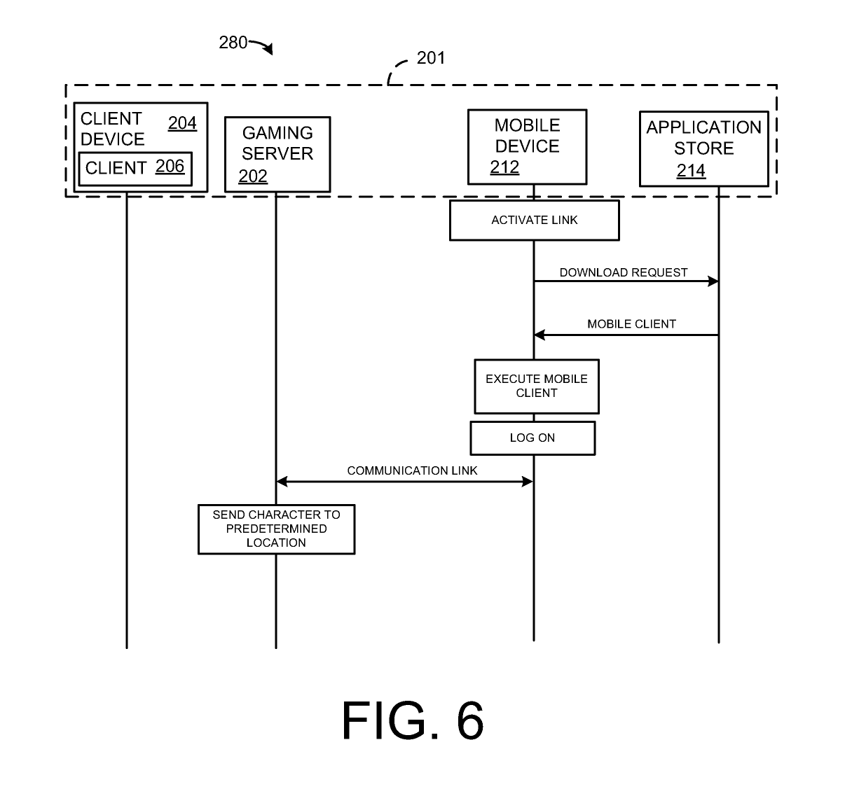

FIG. 6 illustrates a timing diagram 280 for the system 201 where the in-game message generated by the client 206 contains an invitation to the off-line player to join the game at a specific location. In such a situation, the content of the short message output at the mobile device 212 can include a URL link. The URL link can include, for example, a link to download a copy of a mobile client (e.g., the mobile client 66 of FIG. 1). The mobile device 212 can activate the URL link (e.g., in response to user input). The link can direct the mobile device 212 the mobile device to an application store 214 (e.g., an App store) that stores the mobile client. In some examples, the application store can be separate from the gaming server (e.g., on a third party system). In other examples, the application store 214 can be integrated with the gaming server 202.

The mobile device 212 can request a download from the application store 214. In response, the application store 214 can provide the mobile client to the mobile device 212. The mobile device 212 can execute the mobile client. Additionally, the mobile device 212 can employ the mobile client to log on to the gaming server 202. A persistent communication link between the mobile device 212 and the gaming server 202 can be established. Additionally, the mobile device 212 can provide (over the communication link) a location identified in the original short message. The gaming server 202 can send (e.g., virtually teleport) a character (e.g., an avatar) associated with the user of the mobile device 212 (previously the “off-line player”) to a location in the virtual world that is near the character associated with user of the client device 204. In this manner, the gaming server 202 can provide an efficient mechanism to the off-line player that allows the off-line player to join the virtual world at the specific location (e.g., the location of the on-line player).

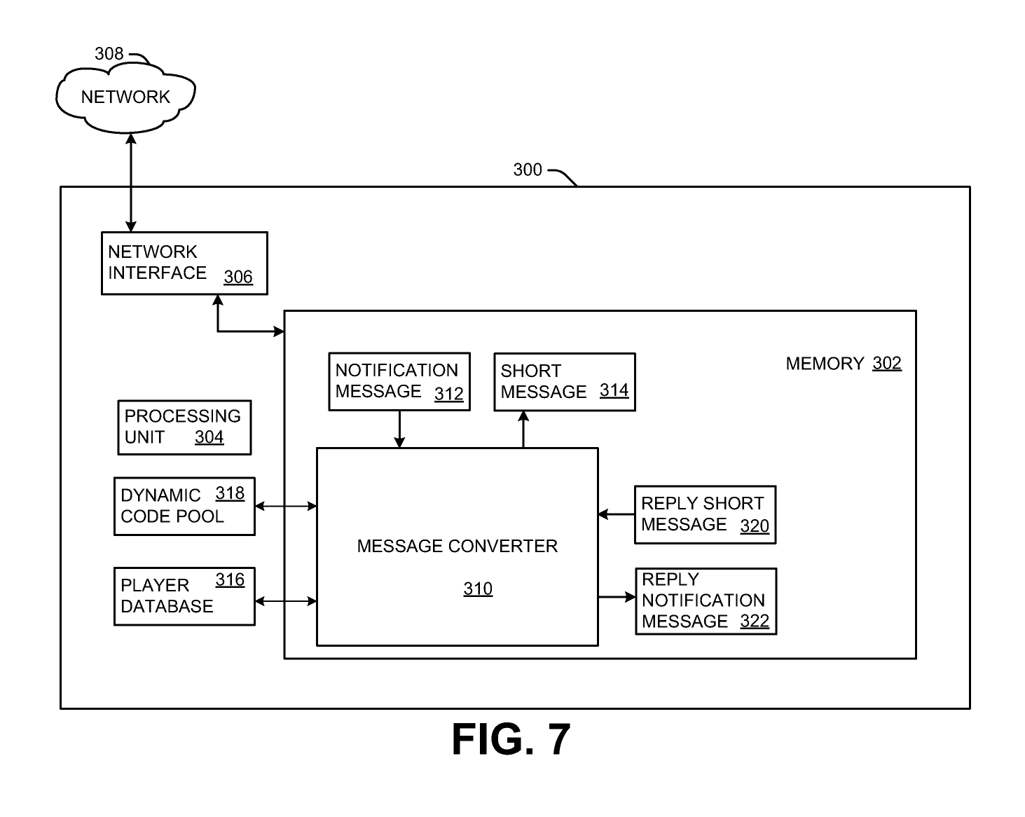

FIG. 7 illustrates an example of a gateway 300 (e.g., a computer system) that could be employed to implement components of the gateway 58 of FIG. 1 and/or the gateway 208 illustrated in FIGS. 3-5. The gateway 300 can include a memory 302 that can store machine readable instructions. The memory 302 could be implemented, for example, as non-transitory machine readable media, such as volatile memory (e.g., random access memory), nonvolatile memory (e.g., a hard disk drive, a solid state drive, flash memory, etc.) or a combination thereof. The gateway 300 can also include a processing unit 304 to access the memory 302 and execute the machine-readable instructions. The processing unit 304 can include, for example, one or more processor cores. The gateway 300 can include a network interface 306 configured to communicate with a network 308. The network interface 306 could be implemented, for example, as a network interface card. The network 308 could be implemented for example, as a public network (e.g., the Internet), a private network (e.g., proprietary network) or a combination thereof (e.g., a virtual private network).

The gateway 300 could be implemented, for example in a computing cloud. In such a situation, features of the gateway 300, such as the processing unit 304, the network interface 306, and the memory 302 could be representative of a single instance of hardware or multiple instances of hardware with applications executing across the multiple of instances (i.e., distributed) of hardware (e.g., computers, routers, memory, processors, or a combination thereof). Alternatively, the computer system 300 could be implemented on a single dedicated server.

The memory 302 can include a message converter 310. The message converter 310 can be configured to receive a notification message 312 from a gaming server (e.g., the gaming server 52 illustrated in FIG. 1) via the network interface 306. The notification message 312 can include content for a message to be provided to a mobile device (e.g. the mobile device 60 illustrated in FIG. 1). The message converter 310 can analyze the notification message 312 and generate a short message 314. The short message 314 can be a pure text message, a URL link, a multimedia message, etc. The short message 314 can be an SMS message, an MMS message, an iMessage, or an OTT message, etc.

In some examples, the notification message 312 can identify a username or character name. In such a situation, the message converter 310 can access a player database 316 to retrieve a telephone number associated with the username or character name. In other examples, the notification message 312 can include the telephone number of the mobile device. In either situation, the message converter 310 can set the TO field of the short message 314 to the telephone number of the mobile device.

The message converter 310 can access a dynamic code pool 318 to retrieve a dynamic code that can uniquely identify the short message 314. The dynamic codes in the dynamic code pool 318 can be assigned to the gateway 300. The message converter 310 can set the FROM field of the short message 314 to the dynamic code retrieved from the dynamic code pool. The content of the short message 314 can include the content (e.g., payload) of the notification message 312. Additionally, in some examples, the message converter can add information, such a sender character name to the short message 314 (e.g., in a tag and/or in content).

The short message 314 can be output to the network 308 via the network interface 306, such that the short message 314 can be provided to the mobile device in a manner described.

The message converter 310 can also receive a reply short message 320 that is provided in response to another short message (including but not limited to the short message 314). The reply short message 320 can be provided from a mobile device via the network 308. The message converter 310 can analyze the reply short message 320 and be configured to generate a reply notification message 322 in response to the reply short message 320. The reply short message 320 can be in the same or different format than the short message 314.

To generate the reply short message, the message converter 310 can identify a dynamic code in the TO field of the reply short message. The dynamic code can uniquely identify an original short message. The message converter 310 can release the dynamic code back into the dynamic code pool 318. Additionally, in some examples, the message converter 310 can examine the FROM field of the reply short message 320 to retrieve a telephone number associated with the mobile device. In such a situation, the message converter 310 can access the player database 316 to identify a username associated with the telephone number included in the FROM field of the reply short message 320. In this situation, the FROM field of the reply notification message 322 can be set to the username retrieved from the player database 316. In other situations, the FROM field of the reply notification message 322 can be set to the telephone number in the FROM field of the reply short message 320.

The content of the reply notification message 322 can include the content of the reply short message. Moreover, the message converter 310 can encapsulate the reply notification message into a network message (e.g., a TCP/IP message) that can be sent to the gaming server.

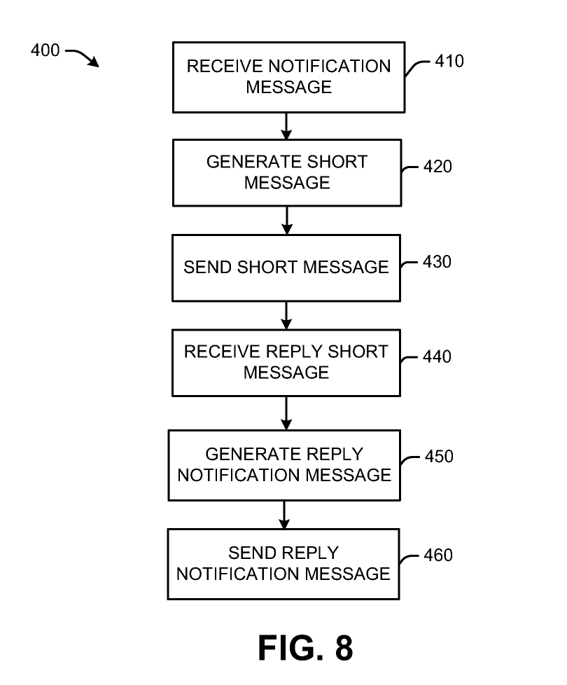

In view of the foregoing structural and functional features described above, example methods will be better appreciated with reference to FIG. 8. While, for purposes of simplicity of explanation, the example method of FIG. 8 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 8 can be implemented as instructions stored in a non-transitory machine-readable medium. The instructions can be accessed by a processing resource (e.g., one or more processor cores) and executed to perform the methods disclosed herein.

FIG. 8 illustrates an example flowchart of a method 400 for providing bi-directional communication between mobile devices and a gaming server vis short messages. The method 400 can be implemented, for example by the gateway 58 illustrated in FIG. 1, the gateway 208 illustrated in FIGS. 2-5 and/or the gateway 300 illustrated in FIG. 7. At 410, the gateway can receive a notification message from a gaming server (e.g., the gaming server 52 illustrated in FIG. 1 and/or the gaming server 202 illustrated in FIGS. 2-6. At 420, the gateway can generate a short message (e.g., an SMS message, an MMS message an iMessage, or an OTT message) addressed to a mobile device (e.g., the mobile device 60 illustrate in FIG. 1 and/or a mobile device 212 identified in FIGS. 3-6) identified (directly or indirectly) in the notification message. At 430, the short message can be sent to the mobile device.

At 440, a reply short message can be received at the gateway. The reply short message can be provided from the mobile device in response to the (original) short message. At 450, a reply notification message that includes the content of the reply short message can be generated by the gateway. At 460, the reply notification message can be sent by the gateway to the gaming server.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory machine readable medium having machine executable instructions comprising a message converter, the message converter being configured to:
generate a reply notification message for a gaming server in response to a reply short message provided from a mobile device, wherein the reply short message is sent in response to an original short message previously sent to the mobile device in response to a request initiated by a client associated with a player of a virtual world implemented by the gaming server.

2. The medium of claim 1, wherein the reply short message is a short message service (SMS) message, a multi-media messing service (MMS) message an iMessage service message or an Overt The Top (OTT) message.

3. The medium of claim 1, wherein the reply short message has a TO field set to a dynamic code corresponding to a FROM field of the original short message.

4. The medium of claim 1, wherein the reply short message includes a command identifier and a command that requests a specific action be performed by the gaming server.

5. The medium of claim 4, wherein the specific action performed by the gaming server changes a state of the virtual world.

6. The medium of claim 1, wherein the message converter is further configured to generate the original short message in response to a notification message sent from the gaming server.

7. The medium of claim 6, wherein a FROM field of the original short message is set to a dynamic code selected from a pool of dynamic codes to uniquely identify the original short message.

8. The medium of claim 6, wherein the notification message includes text generated by the client associated with the player of the virtual world.

9. The medium of claim 6, wherein the notification message and the original short message includes a uniform resource locator (URL).

10. The medium of claim 6, wherein the notification message and the original short message includes multimedia content.

11. A gateway comprising one or more computing devices, the gateway being configured to:
receive a notification message from a gaming server that implements a virtual world, wherein the notification message characterizes a message generated by a client associated with an on-line player of the virtual world that is directed to an off-line player of the virtual world; and
generate an original short message addressed to a mobile device in response to the notification message, wherein a FROM field of the original short message includes a dynamic code associated with the gateway that uniquely identifies the original short message.

12. The gateway of claim 11, wherein the original short message includes a uniform resource locator (URL) that corresponds to a location to download a mobile client for the mobile device.

13. The gateway of claim 12, wherein the original short message includes data characterizing a location in the virtual world.

14. The gateway of claim 11, wherein the original short message is one of a Short Message Service (SMS) message, a Multimedia Message Service (MMS) message an iMessage service message, and an Over The Top (OTT) message.

15. The gateway of claim 11, wherein the gateway is further configured to:
generate a reply notification message for the gaming server in response to a reply short message provided from the mobile device in response to the original short message, wherein the TO field of the reply short message matches the FROM field of the original short message.

16. The gateway of claim 15, wherein the reply short message includes a command identifier and a command for a request for an action in the virtual world.

17. The gateway of claim 11, wherein a TO field of the original short message is set to a telephone number of the mobile device.

18. The gateway of claim 11, wherein the notification message includes a request to send a notification to each mobile device associated with a player of the virtual world that is within a particular area.

19. The gateway of claim 11, wherein the message generated by the client associated with the on-line player is addressed to a character name of the off-line player.

20. A gateway comprising one or more computing devices, the gateway being configured to:
receive a notification message from a gaming server that implements a virtual world, wherein the notification message characterizes a location in the virtual world and the notification message is sent in response to a loss of communication with a client operated by a given player; and
generate a short message addressed to a mobile device associated with the given player in response to the notification message, wherein the short message include a link accessible by a mobile client stored on the mobile device, wherein the link directs the mobile client to the gaming server.

21. A method comprising:
receive a notification message from a gaming server that implements a virtual world, wherein the notification message includes content directed to an off-line player of the virtual world;
generate an original short message addressed to a mobile device associated with the off-line player in response to the notification message, wherein a FROM field of the original short message includes a dynamic code that uniquely identifies the original short message; and
generate a reply notification message for the gaming server in response to a reply short message provided from the mobile device.
